(19) United States
(12) Patent Application Publication
(10) Pub. No.: US 2011/0255786 A1
(43) Pub. Date: Oct. 20, 2011

(54) METHOD AND APPARATUS FOR DETERMINING FLICKER IN THE ILLUMINATION OF A SUBJECT

(76) Inventor: Andrew Hunter, Bristol (GB)

(21) Appl. No.: 12/763,645

(22) Filed: Apr. 20, 2010

(51) Int. Cl. G06K 9/46

(52) U.S. Cl. 382/190

(57) ABSTRACT

A first image frame and a second image frame of an image are captured. A third image frame is formed from at least a portion of the first image frame and a corresponding portion of the second image frame. The third image frame is formed such that the effect of the subject or content of the image is reduced or negated in the third image frame relative to the level of flicker. A flicker pattern is detected using the third image frame. Various techniques are described to capture the second image frame, and for determining the flicker pattern from the third image frame. The flicker pattern may be used to avoid or remove flicker from one or more images, or to correct a captured image.

### BACKGROUND

As mobile phones have become increasingly popular for capturing digital images, there has been a growth in the number of images captured indoors with artificial lights.

Artificial lights, such as fluorescent and incandescent lights, are flickering light sources that can cause very conspicuous and undesirable banding problems in digital imaging systems. Digital cameras can give poor results when photographing subjects that are lit predominantly by such artificial light sources. One problem is that the lights often flicker at a rate that interferes with the capture process. Another is that the lights often have a color temperature that is very different from natural daylight.

Mechanical shutters found in digital cameras can avoid some flicker problems in still images (although not typically in viewfinder displays and captured video). However, mechanical shutters do not currently fit the size and cost budgets of most mass market camera modules.

It is also known for some digital cameras to detect problematic light sources using a dedicated sensor, but again such a solution to the flicker problem would add too much cost or size to a camera phone. As such, the range of solutions presently available for dealing with the problems caused by artificial light sources is severely limited in camera phones.

As an alternative to flicker detection hardware, it is possible to configure digital cameras to suppress flicker of a known frequency in all conditions where artificial illumination might be present, regardless of whether or not the artificial illumination is actually present. This has the disadvantage of constraining camera parameters unnecessarily when flicker is not present in the scene being photographed, and provides no additional information about the type of illumination in the scene (e.g. for use by a colour correction algorithm).

Furthermore, knowing the flicker frequency can itself be a difficult problem, since different countries have different frequencies of alternating current power supplies and these give rise to different flicker frequencies. In particular, some countries use a national standard of 50 Hz, while others use a national standard of 60 Hz.

Referring to FIG. 1, the light output from an incandescent light source (illustrated as waveform 10) depends on the amount of current passing through the filament but not on the direction of the current. The absolute current varies as a rectified sine wave and produces a light output which varies sinusoidally at twice the original AC frequency (i.e. 100 Hz or 120 Hz depending on the national standard). As can be seen from the waveform 10, the intensity of the light output from an incandescent light source is significant even at the trough of the current wave due to the thermal mass of the bulb filament.

Many fluorescent lamps flicker at twice the frequency of the electrical supply (i.e. at 100 Hz or 120 Hz). The profile of the light output from these fluorescent lamps will also have a generally sinusoidal form, but the precise shape depends on the persistence of the lamp phosphors, as illustrated by waveforms 12, 14 and 16 in FIG. 1. The phosphors tend to have a lesser damping effect than the thermal mass of an incandescent filament. Thus, in general, fluorescent light sources are more problematic than incandescent light sources, since the illumination level varies more widely over time.

A measure of the cyclic variation in the output of a light source at a given power frequency is defined using the Illuminating Engineering Society of North America (IESNA) flicker index. The IESNA flicker index is calculated by dividing the area of the illumination profile that lies above the level of average light output by the total area under the level of average light output for a full cycle. The flicker index ranges from zero to one, with higher index values indicating increased levels of visible flicker.

If a camera is equipped with a Global Positioning System (GPS), or some other geographical location system, it may be possible to assume a frequency of flicker by calculating the position of the camera relative to national boundaries and by mapping from each country of operation to an appropriate national flicker frequency. Such systems constrain exposure times to an integer multiple of an expected flicker period according to a table that maps network identifier codes to the AC mains power frequencies for the corresponding countries. In other systems, a table of flicker frequencies can be linked to locally available mobile phone networks. However, with many hundreds of mobile phone networks in operation and new networks being launched every week this is increasingly impractical. Other handset manufacturers require users to configure the mobile phones for 50 Hz or 60 Hz countries manually.

It will be appreciated that all of the systems described above add complexity to a camera and not all camera systems have means for reliably detecting the country in which they are being operated.

### BRIEF DESCRIPTION OF THE DRAWINGS

For a better understanding of the present invention, and to show more clearly how it may be carried into effect, reference will now be made, by way of example only, to the following drawings in which:

FIG. 1 shows the typical light output from incandescent and fluorescent lamps;

FIG. 2 shows how rolling shutters can result in varying image brightness down an image;

FIG. 3 shows how an exposure of exactly one illumination cycle gives consistent image brightness down an image;

FIGS. 4a and 4b show an image having an incorrect white balance and flicker, and are provided to illustrate how the subject of a photograph can be difficult to distinguish from flicker;

FIG. 5 shows a method according to one embodiment;

FIG. 6 further illustrates the method of FIG. 5;

FIG. 7 shows how an exposure time relates to flicker;

FIG. 8 shows how image frames are captured according to a first embodiment;

FIG. 9 shows how image frames are captured according to a second embodiment;

FIG. 10 shows the steps performed by a method according to an embodiment;

FIG. 11 shows the steps performed by a method according to another embodiment;

FIG. 12 shows how pixel values vary along a column of a third image frame;

FIG. 13 shows how pixel values vary along a column of a third image frame having image noise;

FIG. 14 shows how crossing point estimates may be derived;

FIG. 15 shows how a histogram of crossing point estimates may be used determine a flicker pattern;

FIG. 16 shows the steps performed by a method according to yet another embodiment;

FIG. 17 illustrates how a flicker pattern may be detected according to various embodiments;

FIG. 18 illustrates how the various embodiments can be used to correct at least part of an image;

FIG. 19 shows a first arrangement;

FIG. 20 shows a second arrangement; and

FIG. 21 shows an apparatus according to one embodiment.

### DETAILED DESCRIPTION

The embodiments below will be described in relation to determining flicker in the illumination of a subject. Determining flicker is intended to include, but not be limited to, determining a flicker frequency and/or flicker phase and/or flicker strength of an illumination of a subject. Furthermore, the embodiments will be described in relation to determining flicker in the illumination of a subject using apparatus that may form part of a camera, for example a camera phone, and whereby the camera utilizes CMOS image sensor technology. It will be appreciated, however, that the embodiments are intended to be more generally applicable to other forms of digital camera and other forms of sensor technology.

The majority of camera phone modules are based on CMOS image sensor technology. Most of these have an electronic exposure control mechanism known as a “rolling shutter”. The concept is very similar to a rolling focal plane shutter in a 35 mm Single Lens Reflex (SLR) camera. An SLR focal plane exposure begins as one curtain is pulled open across the image area, and ends as another curtain travelling in the same direction and at the same speed is pulled shut. The exposure time is determined by the time delay between the transit of the two curtains (which can be very short indeed), and not by the speed of curtain movement.

In a CMOS image sensor, the individual rows of the image are reset in sequence to initiate the exposure. The rows are then read out in the same direction and at the same speed to end the exposure. The exposure time is determined by the time delay between the reset and the read of any one line, not by the rate at which the reset or read propagate across the image. An advantage of this exposure scheme is that exposure times can be much shorter than would be possible for a moving mechanical shutter. A disadvantage, however, is that the exposure of each row of the image is slightly shifted in time.

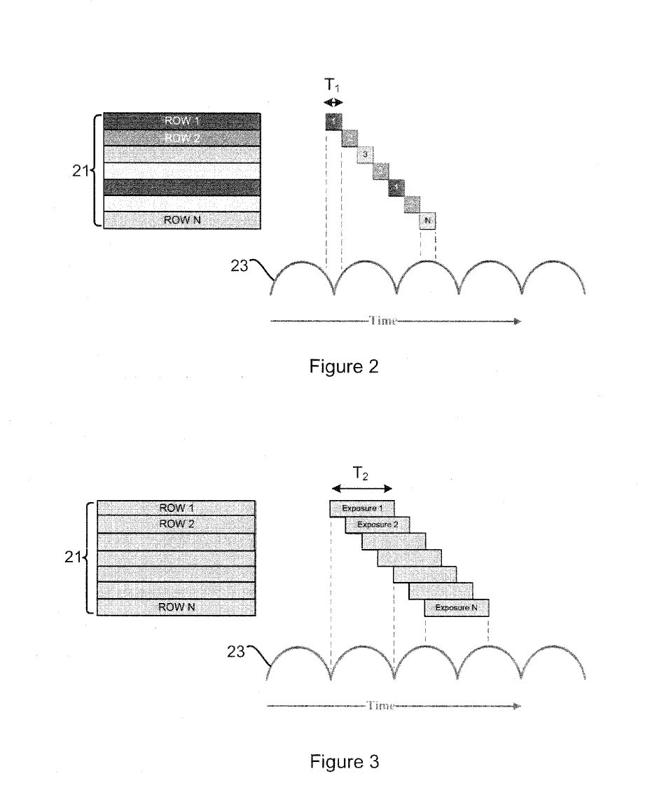

Referring to FIG. 2, a CMOS image sensor 21 captures an image by partitioning the image into a plurality of lines, shown as Rows 1 to N. An artificial light source, such as a fluorescent lamp, produces a light having an illumination level that varies as shown by the waveform 23. A short rolling shutter exposure, for example having an exposure duration of T₁ corresponding to about a quarter of an illumination cycle as shown in FIG. 2, will form an image of varying intensity according to the phase of the illumination flicker during the exposure of each image line. For example, Row 1 will have an exposure level “1” which is darker than the exposure level “2” of Row 2. This is because Row 1 is exposed when then the illumination level from the light source is at a trough (i.e. a trough of waveform 23), while Row 2 is exposed when the light source has a higher illumination level. As a result, bands of light and dark will appear down the image producing a characteristic flicker pattern.

Referring to FIG. 3, if on the other hand an image is captured with a rolling shutter having an exposure duration of T₂, which corresponds substantially to one full illumination cycle (or an integer multiple of one cycle), then the image will not exhibit a flicker pattern since each image line is exposed to the same average illumination level.

According to a first embodiment, a method is provided for determining flicker in the illumination of a subject by capturing and processing two images of a subject, the flicker caused by an artificial light source that illuminates the subject. The method comprises the steps of using actual image data collected by an image sensor, for example a CMOS sensor, during normal operation of a camera, for example during viewfinding or video capture. As will be described in greater detail below, the various embodiments enable flicker to be detected using a plurality of exposures of different durations or captured at different temporal offsets in the flicker cycle.

Using the image data itself has the advantage of avoiding manual intervention by the user, and avoids a handset manufacturer having to devise a scheme to determine all the local flicker frequencies. It has the further advantage of capturing additional information about the characteristics of the light source which can be used, if desired, for correcting the image white balance.

The method also avoids unnecessary exposure constraints when no flicker is present. Once a flicker frequency has been determined, an image exposure period can be matched to the flicker period in order to avoid any visible flicker artifacts in viewfinder, video and still images.

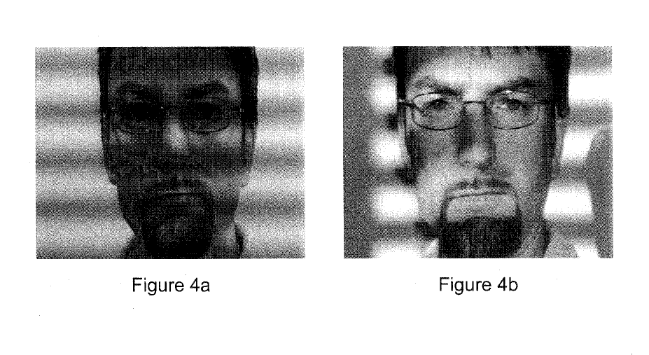

Referring to FIGS. 4a and 4b, characteristic bands of light and dark can be seen in the flicker pattern in FIG. 4a. The spacing of the bands relates to the AC frequency of the local mains supply and the sensor read rate. It might seem a simple task to measure the separation of the bands for a known sensor read rate in order to determine the flicker frequency. However, the bands can be very difficult to distinguish from image features, as illustrated by the subject of FIG. 4b, which has similar illumination patterns due to light passing though a banded obstruction.

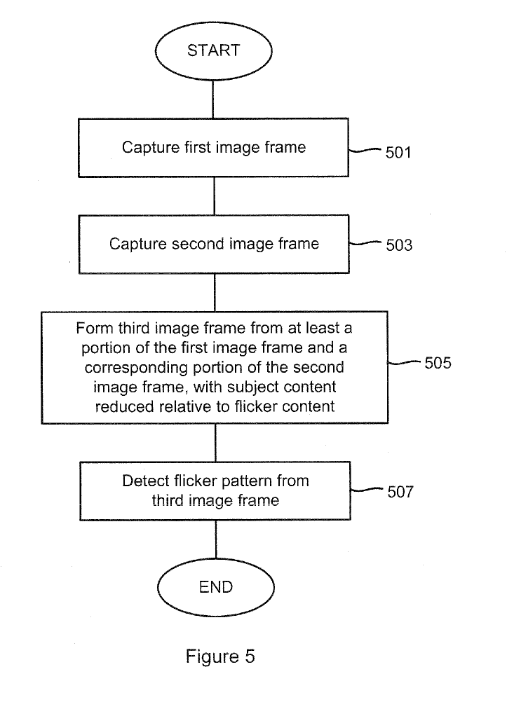

FIG. 5 shows the steps performed by an embodiment according to a first method. In step 501a first image frame of a subject is captured. The first image frame can be one of a set of image frames, for example one of a set of viewfinder image frames. A second image frame of the subject is captured in step 503. A third image frame is then formed, step 505, from at least a portion of the first image frame and a corresponding portion of the second image frame. The third image frame is formed such that the effect of the subject or content of the image is reduced or negated in the third image frame relative to the flicker content, thereby enabling the flicker pattern to be detected using the third image frame in step 507 more reliably. In other words, the magnitude of the signal due to the subject matter in the third image frame is significantly diminished relative to the magnitude of the flicker pattern in the third image frame. It is noted that determining the flicker pattern may include one or more of determining the flicker frequency and/or the flicker phase and/or the flicker strength of an image.

The third image frame may be formed, for example in an embodiment that uses different exposure periods for the first and second image frames, by comparing a pixel value from the first image frame (for example a color channel value of a given pixel) with a corresponding pixel value from the second image frame. The comparison may comprise a ratio or scaled difference of the first pixel value with the second pixel value. A scaled difference corresponds to where one or both of the image signals are amplified or attenuated to have the same level for the same subject matter in the first and second image frames. For example, if the first image frame has half the exposure of the second image frame, then the first image frame can be amplified by two. In an alternative embodiment the third image frame may be formed by comparing at least one pixel from the first image frame with a corresponding pixel or pixels from the second image frame, wherein the first image frame and second image frame are captured at different temporal offsets in the flicker cycle. Further details of these embodiments will be given later in the application.

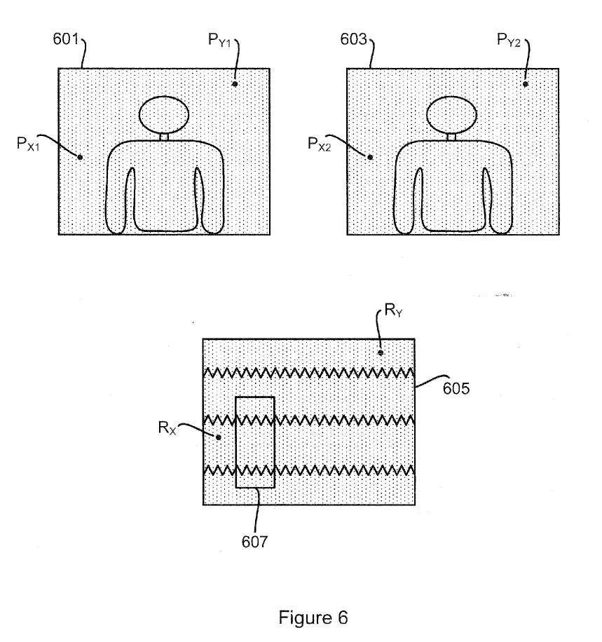

FIG. 6 is provided to further explain the method of FIG. 5. FIG. 6 shows a first image frame 601 and a second image frame 603 of a given subject. A third image frame 605 is formed from the first image frame 601 and the second image frame 603. The third image frame is formed such that the effect of the actual subject or content of the image is substantially reduced or nullified in the third image frame 605. FIG. 6 shows the entire first image frame 601 and entire second image frame 603 being used to form the third image frame 605. As mentioned above, however, the third image frame 605 may be formed from just a portion of the first image frame 601 and a corresponding portion of the second image frame 603 (for example a portion 607), which in certain applications will be sufficient to determine a parameter of the flicker pattern. In such a situation, one or both of the frames being captured could also be limited to just capturing the relevant portion of the image. It is noted that a portion of an image frame can comprise either a contiguous or non-contiguous portion. For example a portion of an image frame may comprise a plurality of scattered sub-portions across the image frame.

If the first image frame and the second image frame are captured using different exposure periods, for example, (i.e. a first exposure period and a second exposure period, respectively), then a pixel value of a pixel P_{X1} in the first image frame 601 and a pixel value of a corresponding pixel P_{X2} in the second image frame 603 will have a ratio R_{X}.
i.e. R_{X}αP_{X2}/P_{X1}

The value R_{X} will be proportional to the ratio of the second exposure period over the first exposure period.

Thus,
R_{X}αP_{X2}/P_{X1} α second exposure period/first exposure period

It is noted that the proportionality may be subject to a scale term or an offset, for example a scale term to allow for changes in signal gain. If it is assumed that the content or subject of the first image frame 601 is substantially identical to the content or subject of the second image frame 603 (for example if the first and second image frames 601 and 603 are captured in quick succession such that there has been little or no movement between image frames), and if it is assumed that there is no image noise or flicker present in the captured image, then the ratio R_{Y} of a pixel value of a pixel P_{Y1} from the first image frame 601 compared to a corresponding pixel value of a pixel P_{Y2} from the second image frame 603 will be the same as the ratio R_{X}. Likewise, any corresponding pixels in the first and second image frames 601, 602, will also have the same ratio R.

However, if a flicker pattern is present in the captured image, the ratio Rx corresponding to one pair of pixels will vary compared to a ratio Ry of another pair of pixels. This variation is used to detect the flicker pattern in the image, as will be described in further detail later in the application. It will be appreciated that the ratio of one pixel value compared to another reduces or nullifies the effect of the actual content of the image, thereby making the flicker pattern easier to determine.

Any color channel may be compared with the same color channel of a corresponding pixel. For example, the signal level of one or more of the red, blue or green color channels of one pixel may be compared with the same one or more of the red, blue or green color channels of a corresponding pixel. According to one embodiment the signal level on a green channel of one pixel in the first image frame 601 is compared with the signal level on the same green channel of a corresponding pixel in the second image frame 603. If a demosaicing operation is to be performed during pixel processing, the comparison may be carried out either before or after the demosaicing operation.

As mentioned above the third image frame 605 does not necessarily have to comprise the same number of pixels as provided in the first and second image frames 601, 603. For example, the third image frame 605 may be formed from just a portion of the first image frame 601 and second image frame 603, for example a portion 607 that is sufficiently large to enable a flicker pattern to be detected.

However, as will be discussed later in the application, having a third image frame 605 comprised of each pixel from the first image frame 601 and the second image frame 603 enables enhanced image processing to be performed over the entire image. It is noted that enhanced processing over the entire image may also be achieved by using fewer pixels in the third image itself, for example a proportion of pixels distributed across the entire image, for example every fourth pixel.

The third image frame 605 may be subject to processing, for example filtering, prior to the flicker pattern being detected, as will be described later in the application.

Although FIGS. 5 and 6 discuss first and second frames being captured, it is noted that the embodiments may capture more than two frames.

A first image frame might be one of a sequence of frames having an exposure period chosen according to the needs of video capture or view finding, while a second image frame might have an exposure period chosen to maximise the banding effect of flicker. In such a case, the second image frame can be considered to be an additional frame that is captured with the one or more normal first image frames.

According to one embodiment, additional one or more exposures are captured using a predetermined exposure period. For example, the predetermined exposure period can be chosen in order to maximise the detectability of flicker for 50 Hz and 60 Hz power supplies. For example, an exposure period of 4.2 ms may be used. It will be appreciated, however, that other exposure periods can be used without departing from the scope of the invention. Furthermore, when there is more than one additional exposure, it is noted that at least one of these additional exposures can have a different exposure period from the others.

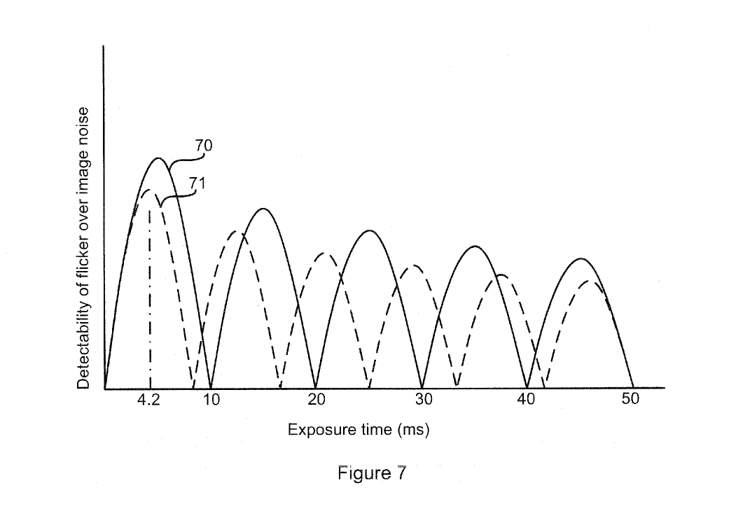

FIG. 7 shows the flicker detectability of 100 Hz flicker (shown as solid line 70) and 120 Hz flicker (shown as doted line 71) for different exposure periods. The exposure duration may be chosen such that it provides a suitably high detectability for both the 100 Hz and 120 Hz flicker frequencies. For example, an exposure time of 4.2 ms can provide advantages for discerning the flicker pattern. As mentioned above, exposure times other that 4.2 ms may be used. The exposure period can be chosen such that it avoids exposures periods that are close to multiples of the flicker periods. Many factors can affect the choice of the predetermined exposure period for a given application. For example, in one embodiment the exposure may be chosen such that it fits between normal viewfinder or video frames (as described later in the application), in which case the exposure period can be chosen to be much shorter than a normal frame period ( 1/15th second and 1/30th second being typical of viewfinder and video frame periods).

According to another embodiment, in certain applications it may be desirable to have the exposure period chosen to be as short as possible so that any variation in signal during a fractional part of a flicker cycle is not masked by a much larger signal built up over any full flicker cycles that occur during the exposure.

According to yet another embodiment, the exposure period can be chosen such that it is not so short that random noise introduced during the readout process can mask any flicker pattern in the signal. It is noted that any one or more of these factors in combination may also be taken into consideration when determining the exposure period of the one or more additional exposures.

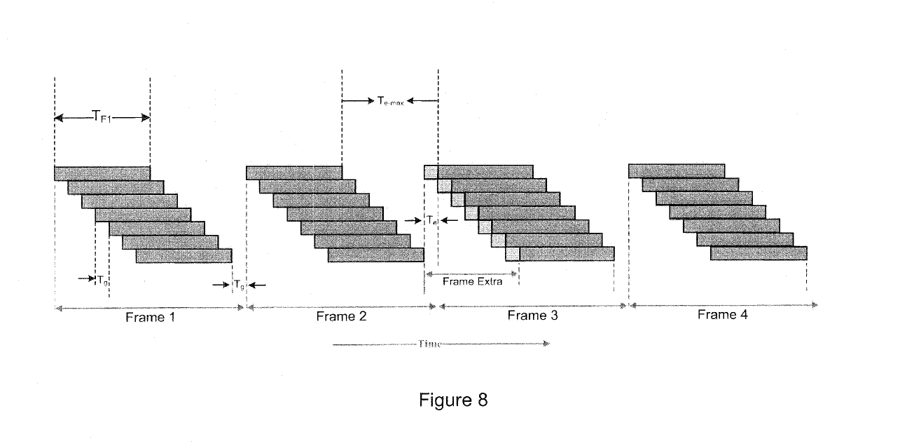

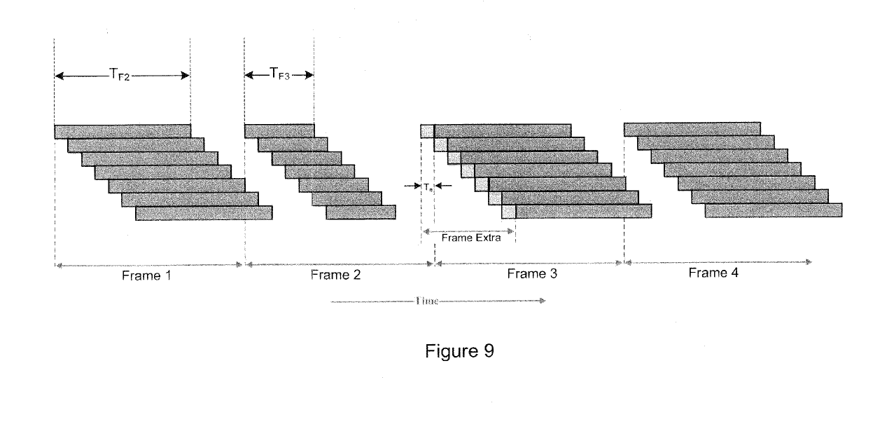

FIGS. 8 and 9 describe in further detail how an additional frame, having a different exposure period to an original frame, may be captured.

Referring to FIG. 8, this illustrates how a set of image frames, for example image frames 1 to 4, may be captured for display on a viewfinder of a camera. If the prevailing exposure times T_{F1} of such image frames are sufficiently short, an addition image frame Frame_{EXTRA} may be captured without interrupting the flow of standard viewfinder frames. The additional frame Frame_{EXTRA} has an exposure time Tₑ that is different to the exposure time T_{F1} of the standard viewfinder frame. FIG. 8 illustrates an embodiment with a conventional rolling shutter as is often found on CMOS image sensors. In such an embodiment, only one row can be read out at a time, and each row being read out must be separated by at least one row readout period T_{g} (i.e. the shortest period during which the sensor can read one row and then be ready to read another). Thus, in the context of FIG. 8, “sufficiently short” means that there is time to read a short exposure in the interval T_{g} between reading the last row of the previous viewfinder frame and reading the first row of the next viewfinder frame. In other words, there should exist time to read an entire normal viewfinder frame and an entire additional frame within a single frame period. This is easiest when the rows are read out at the maximum rate of the image sensor (which they normally would be to minimize temporal differences between the image rows which might cause distortion of moving images). The prevailing exposure time (i.e. of Frame 2) can be at most one prevailing frame period minus the exposure time Tₑ of the extra frame.

The exposure period Tₑ of the additional image frame Frame_{EXTRA} can be any period up to the duration of the time difference between the prevailing frame period and the prevailing exposure time, shown as the time period Tₑ₋ₘₐₓ in FIG. 8. In other words, the additional image frame exposure can begin as soon as the corresponding row of the previous viewfinder frame has been read out, but does not end until at least one row readout period after the last row of the previous viewfinder frame has been read out.

Referring to FIG. 9, if the prevailing viewfinder exposure times T_{F2} are long (for example having a duration of one full frame period), or such that an insufficient gap exists between successive frames to allow a predetermined exposure period for the additional frame, it may be necessary to capture one of the viewfinder frames (for example Frame 2) with a shorter than normal exposure time T_{F3}, or to omit one such frame entirely, in order to free up a time slice for the additional exposure, for example at 4.2 ms. To compensate for the shorter than normal frame, or the omitted frame, the gain of the captured Frame 2 can be increased to offset the reduced exposure period, or Frame 2 computed from one or both of its neighbouring frames, Frames 1 and 3.

For example, in the embodiment illustrated in FIG. 9, one of the normal exposure periods can be cut in half (T_{F3}). To avoid the half exposure frame (i.e. the one having less signal because it received less exposure) being visibly darker than others when displayed as part of a viewfinder sequence or recorded as part of a video sequence, the signal can be gained (i.e. amplified, in this case doubled in strength) to approximate the signal level that would have been achieved with the prevailing exposure period. Further processing may also be applied to this frame to minimize the visible effect of the corresponding doubling of image noise levels (for example applying appropriate levels of known conventional noise reduction techniques). Variations of the method described in this particular embodiment may include introducing a slight time delay so that the shorter frame (Frame 2) is still timed to occur centrally between Frame 1 and Frame 3.

According to an alternative embodiment, rather than adjusting the gain of Frame 2 as mentioned above, Frame 2 may be dropped from the sequence and a replacement frame computed from one or both of Frames 1 and 3. Other methods of compensating or replacing Frame 2 are also intended to be embraced by the embodiments described herein.

The additional short exposure and the subsequent normal viewfinder frame are captured in quick succession to minimize any subject or camera motion (i.e. such that there is the highest likelihood of the subject of the scene being the same in both image frames). The additional short exposure frame and the normal viewfinder frame can then be used to determine flicker in the image.

In the rolling readout scheme of FIGS. 8 and 9, it can be seen that the additional image frame (Frame_{EXTRA}) and the subsequent frame (Frame 3) are closest in succession. This is because the readout of each row of the extra frame (Frame_{EXTRA}) can be timed to occur just as the exposure of the same row of the subsequent frame (Frame 3) begins.

It is noted that although the embodiments above refer to comparing an additional image frame with an adjacent subsequent normal frame, the additional image frame may also be compared with any preceding or subsequent normal frame, preferably, but not limited to, any adjacent frame. For example, readout schemes may exist in which the extra frame and previous frame can be captured in quick succession. Read out schemes may also exist that allow the normal and additional frame exposure periods to overlap, for example where each is derived from interlaced fields of an image sensor.

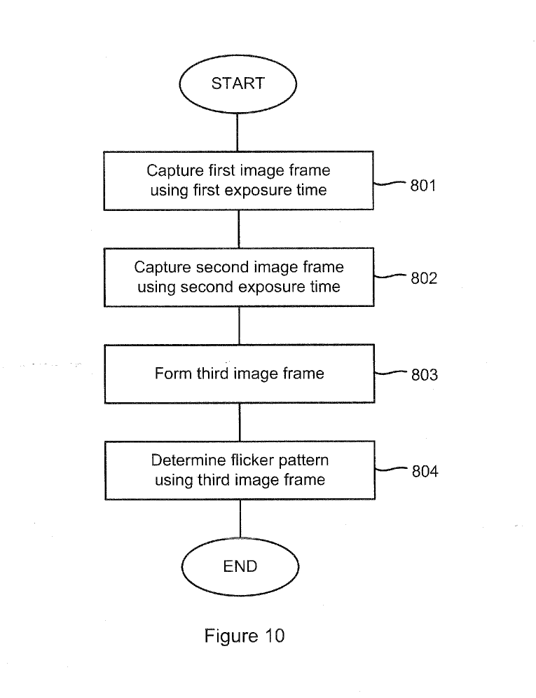

FIG. 10 describes the steps performed by an embodiment. In step 801a first image frame is captured using a first exposure time. The first image frame can be one of a set of image frames that are captured at the first exposure time, for example viewfinder image frames. In step 802 a second image frame is captured using a second exposure time. The second image frame is an image frame that is adjacent the first image frame, i.e. a succeeding or preceding image frame of the first image frame. In step 803 a third image frame is formed using at least a portion of the first image frame and at least a corresponding portion of the second image frame. The third image frame is then used to determine a flicker pattern in the image, step 804. It is noted that determining the flicker pattern may include one or more of determining the flicker frequency and/or the flicker phase and/or the flicker strength of an image.

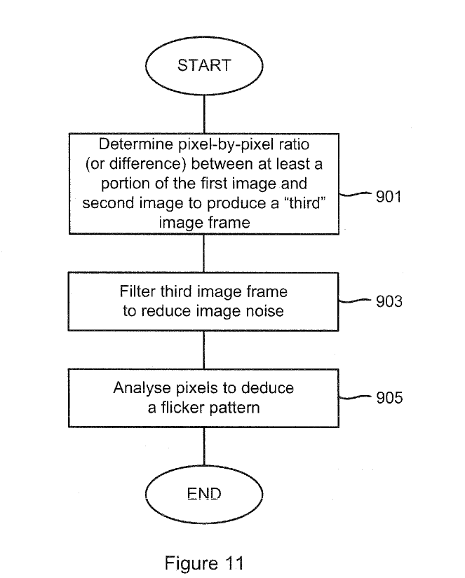

Referring to FIG. 11, according to one embodiment the flicker pattern may be determined as follows. In step 901a pixel-by-pixel ratio (or scaled difference) is determined between at least a portion of the first image frame and at least a corresponding portion of the second image frame, i.e. having a first exposure (e.g. short exposure) and a second exposure (e.g. normal exposure), respectively. In other words, the ratio or scaled difference between a value of a pixel in the first image frame and a value of a corresponding pixel in the second image frame is determined, the ratio or scaled difference referred to hereinafter as a “comparative pixel value”. The one or more of such comparative pixel values form a third image frame. The third image frame will be a substantially uniform image, with every pixel value equal to the ratio (or scaled difference) of the exposures provided there is no image noise, no motion and no flicker. However, when flicker is present, the third image frame (i.e. the pixel-by pixel ratio or scaled difference of the first and second exposures) will have the form of smoothly changing light and dark bands in the third image frame, as shown in the third image frame 605 of FIG. 6 above.

The third image frame may be filtered, if desired, using a low pass filter, as shown in method step 903 to suppress the effects of any image noise without significantly affecting the flicker pattern. The comparative pixel values corresponding to the pixels in the third image frame may then be analysed to deduce a flicker pattern in the image, step 905. The filtered result will often reveal very subtle flicker that would normally not be visible in a captured image. It is noted that the step of filtering the third image frame data to reduce image noise is an optional procedure, however, and can be omitted if desired. Further details will now be given regarding how the flicker pattern may be detected from the third image frame.

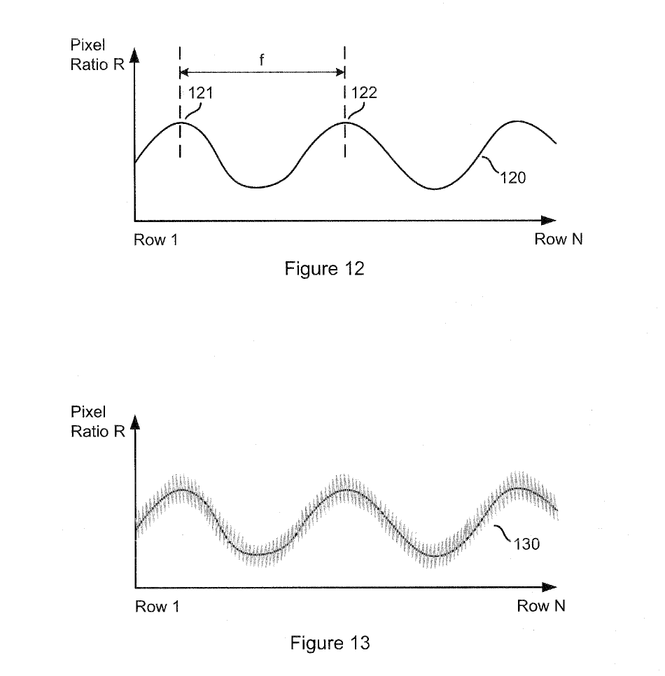

FIG. 12 shows a representation of how the ratio value R would vary down a column of pixels in a third image frame, i.e. from Row 1 to Row N, assuming that flicker is present, that there is no image noise, and that the image content from the first and second image frames is identical. The ratio R varies according to the flicker frequency of the illumination source and the readout rate. In such a scenario the frequency of the flicker pattern can therefore be detected by detecting first and second peaks 121, 122 in the waveform 120, and determining the flicker frequency “f” using this information, or otherwise detecting the troughs or the cyclic pattern in the waveform.

However, if image noise is present, then the ratio value R varies down a column of the third image frame as shown in FIG. 13. This can make the frequency of the flicker pattern in the waveform 130 more difficult to determine, i.e. because the pixel ratio value can vary significantly from one pixel to an adjacent pixel due to image noise. The filtering of the third image frame, as mentioned above in step 903 of FIG. 11, helps reduce the effect of image noise and thus provide a waveform which is more similar to that of FIG. 12.

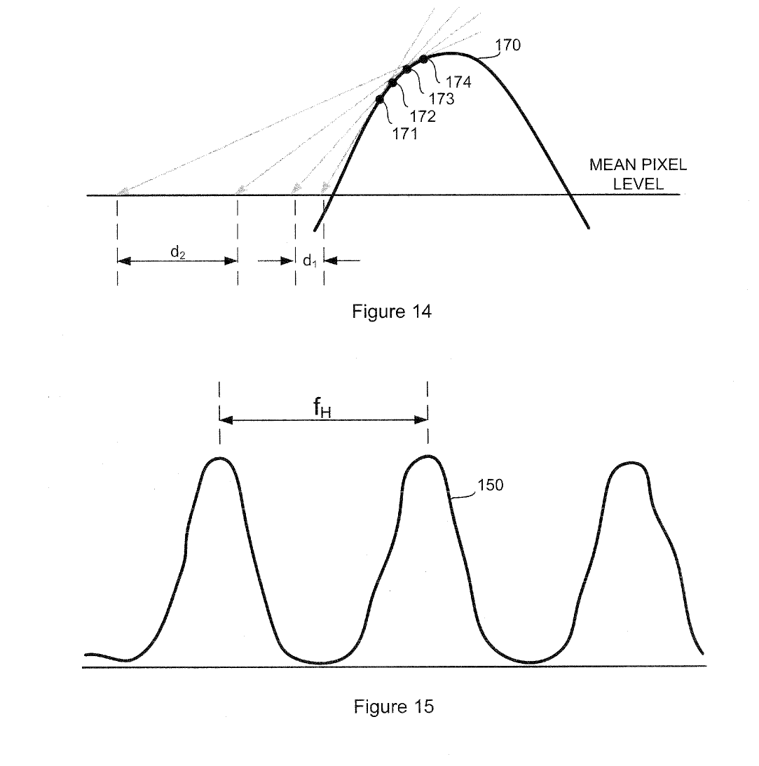

A number of techniques may be provided to determine the flicker pattern from the type of waveforms shown in FIGS. 12 and 13. For example, FIG. 14 shows a method according to one embodiment. A local gradient is measured in each column of pixel data from the third image frame. As will be seen, depending on the gradient of the waveform 170, the distance d1 between crossing points of respective tangents to first and second pixels 171, 172 in the column of pixel data will differ from the distance d2 between crossing points of respective third and fourth pixels 173, 174 in the column of pixel data (the “crossing points” being, for example, the crossing points with a mean pixel value). There will be a clustering of points around d1, i.e. at a point where the sinusoidal waveform is at its steepest, and this clustering of points is used to determine the flicker pattern.

The crossing point of a given pixel, for example pixel 172, can be estimated by taking a gradient from adjacent pixels 171 and 173. A histogram of crossing point estimates 150 can then be produced as shown in FIG. 15. The histogram of crossing point estimates 150 makes it easier to detect peaks, and hence the frequency f_{H} of the histogram, which in turn relates to the frequency of the flicker pattern. For example the frequency of the histogram of crossing point estimates 150 can be checked to determine if it corresponds to a first flicker pattern frequency, for example 100 Hz, or a second flicker pattern frequency, for example 120 Hz.

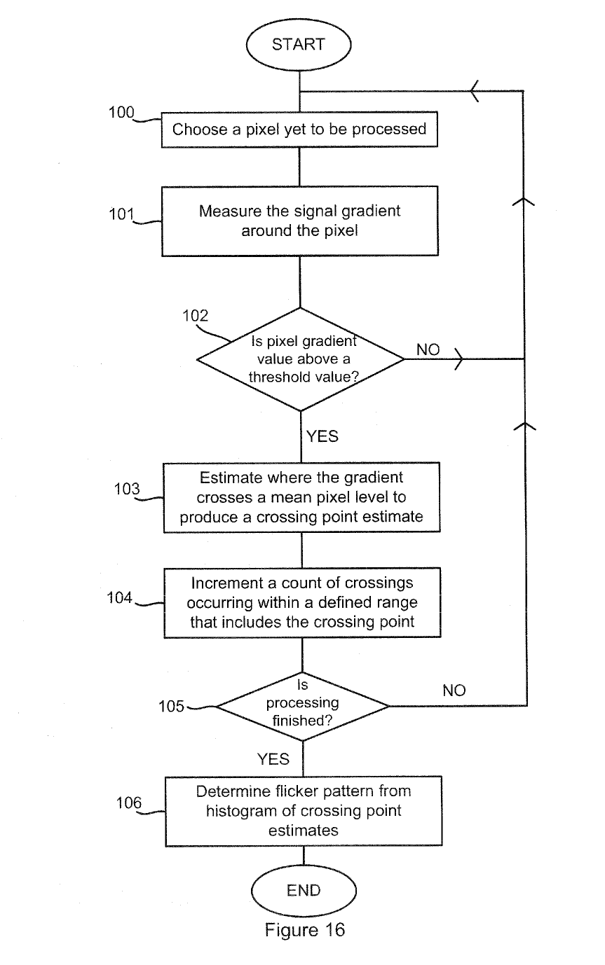

FIG. 16 describes an embodiment that may be used to detect a flicker pattern, including the frequency and/or phase of such a flicker pattern, in the third image frame as described above. If desired, the strength of the flicker can also be determined. In step 100 a pixel yet to be processed is chosen. In step 101 the local gradient around the pixel is measured. The local gradient may be determined by comparing a comparative pixel value (for example ratio or scaled difference) of a first pixel with a comparative pixel value of a neighbouring pixel in a particular column of the third image frame, i.e. comparing with a pixel above or a pixel below (or by comparing the two pixels straddling the pixel of interest). In step 102 it is determined whether a pixel gradient value is above a threshold value. This step is optional, and may be carried out to ensure that only crossing points from certain parts of a waveform are used to generate the histogram of crossing point estimates. It is noted that, regardless of this, crossing points of interest should lie within the current cycle. If it is determined in step 102 that the pixel gradient value is not above a threshold value, processing returns to step 100 and another pixel yet to be processed is chosen. For all pixels having a gradient value above a threshold value, it is estimated where (up or down the column) the gradient will cross the mean pixel level, step 103 (the mean pixel level being equal to the ratio of the exposure times of the two frames). In step 104 a count is incremented of crossings occurring within a defined range that includes the crossing point. If it is determined in step 105 that processing has not been completed, processing returns to step 100. If processing has been completed, for example after processing many thousands of these estimates, a histogram of crossing point estimates is used to determine the flicker pattern, step 106. This may be determined by deducing peaks in the histogram of the crossing point estimates. Although spurious data from image noise or inter-frame motion can randomly perturb the predictions of individual crossing points, such spurious data will not generate large false peaks.

According to one embodiment a histogram may be accumulated by accumulating peaks from multiple columns and overlaying peaks down a column for an assumed frequency.

In this manner data is aggregated prior to the data being analysed to determine a flicker pattern. This has the advantage of making the analysis easier, since it reduces the effect of noise.

The histograms of crossing point estimates enable the presence of flicker to be detected (by the presence or absence of peaks), the strength of the flicker (for example, by a measure of the areas above and below the mean level of the histogram), the frequency of flicker (by separation of the peaks) or the phase of the flicker pattern. For example, the distance to peaks in the histogram of crossing point estimates may be used to determine the phase of the flicker pattern (for example relative to the top of the image frame). The presence of flicker and its strength can be used with white balance algorithms, if present, to help improve the color accuracy of the camera module. For example, if strong flicker is detected in a scene, the embodiments can eliminate daylight from the set of possible illuminants.

The spatial flicker strength may be determined as follows. Once the flicker phase and frequency have been determined using one of the methods described above, an “ideal flicker pattern” can be created. The ideal flicker pattern can then be compared with the actual flicker pattern to determine the strength of the flicker pattern across the image frame. This enables only portions of the image frame having flicker to be corrected, rather than the entire image frame.

In addition, by determining the strength of the flicker pattern across the entire image, this enables the color adjustment of those portions having artificial light or natural light to be corrected differently.

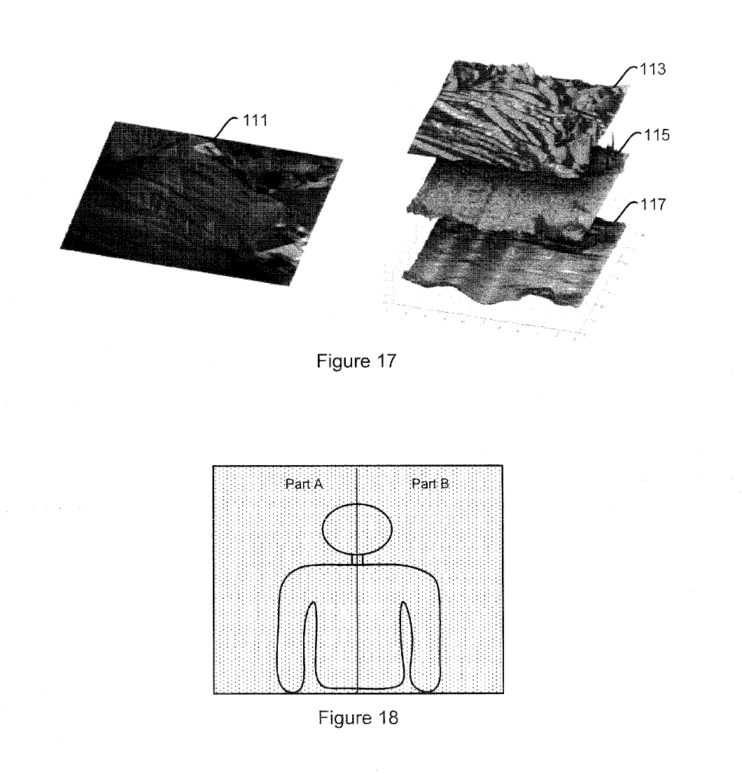

FIG. 17 illustrates a first image frame 111, for example view-finder image data. The frame 113 relates to a second image frame, for example taken with a different exposure to the first image frame 111. As can be seen, features of the subject of the first image frame are still discernable from the second image frame 113. For example, folds in the shirt of the person in the image can be seen in the second image frame 113, thereby making it difficult to determine a flicker pattern from such an image frame. The third image frame 115 is formed according to one of the methods described above, for example based on the ratio of some form of pixel value between the two images, i.e. captured at the first and second exposure periods. Subtle peaks can be discerned from the third image frame 115, which may be used to determine the flicker pattern according to any one of the embodiments described above. However, image frame 117 relates to the smoothed ratio image (i.e. filtered ratio data) which, as can be seen, reveals a wave-like flicker pattern more clearly. Amplification of the image frame 117 may also be provided to enable the flicker pattern to be determined more easily. The filtered image frame 117 can be used to determine a flicker pattern as described in any of the embodiments described above.

The flicker pattern may be determined across a portion of the scene, or across the entire scene using data from the viewfinder. According to a further embodiment, it is possible to map the local flicker strengths across the entire scene. By mapping the local flicker strengths in this way, it is possible to estimate the local strengths of mixed light sources in order to control a locally adaptive white balance algorithm. In such an embodiment, it is possible to correct for the variable proportions of natural and artificial light at each image point.

FIG. 18 shows an image frame, a first part of which (Part A) is illuminated from a natural light source, and a second part of which (Part B) is illuminated mostly from an artificial light source having a flicker frequency. As mentioned above, if the flicker strength is determined for the entire image frame, this enables a portion of image illuminated by artificial light to be differentiated from a portion of the image illuminated by natural light (i.e. in which no flicker is present). This also enables the relative proportion of daylight and artificial light to be estimated at every point. Dark and bright regions with strong flicker will provide a reasonable estimate of the flicker index. Any dilution of flicker strength is likely to be due to the proportion of non-flickering daylight present. It is noted that a “portion” described above may comprise a single portion, or two or more non-contiguous portions across the image. The above enables those portions having artificial light to be processed differently to those portions not having artificial light, for example the color adjustment of those portions having artificial light or natural light to be corrected differently.

A map of flicker strengths across an entire scene can also enable flicker to be corrected after capturing a still image. Normally, it is necessary to set an exposure value that eliminates flicker before an image is captured. In some unusual circumstances, for example when a flickering light source is very bright, it is not possible to set an exposure long enough to suppress flicker without also over-exposing the image. In these cases, most flicker suppression systems fail. The embodiment described above therefore enables flicker to be corrected in a captured image, since it enables flicker to be removed from the captured image, because the flicker strength is known for all image points, hence enabling the flicker to be fully corrected.

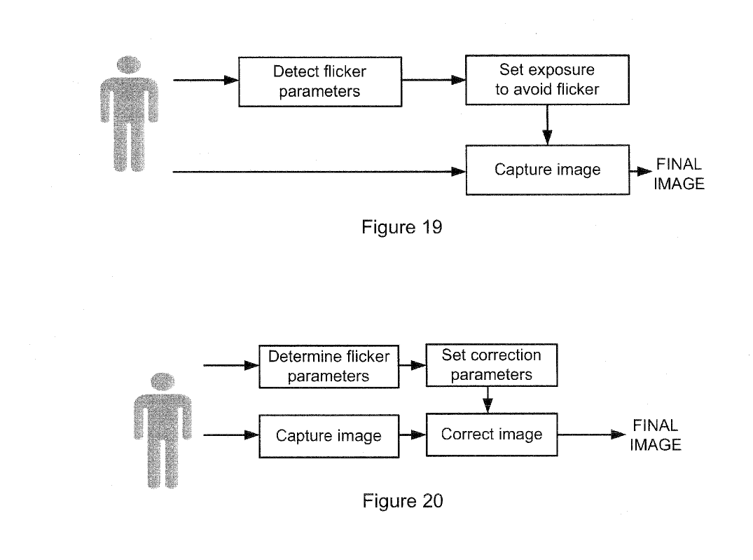

FIG. 19 shows an arrangement in which flicker parameters are detected, and used to set an exposure period of a next image to be captured.

FIG. 20 shows such an arrangement whereby the flicker parameters are first detected, and a captured image then corrected to produce a final image.

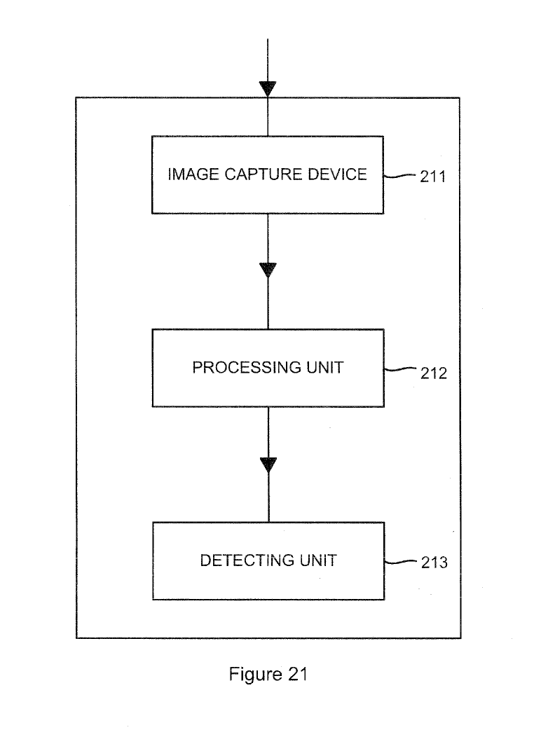

FIG. 21 shows an apparatus according to one embodiment. An image capture device 211 captures a first image frame of an image and a second image frame of an image. A processing unit 212 is adapted to form a third image frame from at least a portion of the first image frame and a corresponding portion of the second image frame, wherein said third image frame has reduced subject information compared to the first and second image frames. A detecting unit 213 is adapted to detect a flicker pattern from the third image frame.

According to another embodiment, there is provided a method of processing an image, comprising the steps of determining a flicker strength parameter for each of a plurality of pixels in an image; and adjusting the processing of each of the plurality of pixels according to its respective flicker strength parameter. The adjusting step may comprise the step of correcting a color or white balance of the respective pixel.

According to another embodiment, there is provided an apparatus for processing an image, wherein the apparatus comprises a processing unit adapted to determine a flicker strength parameter for each of a plurality of pixels in an image, and process each of the plurality of pixels according to its respective flicker strength parameter. The processing unit may be further adapted to correct a color or white balance of the respective pixel.

According to another embodiment, there is provided a camera comprising an apparatus as described in any of the embodiments above, or for performing the methods described above.

As will be appreciated from the above, the various embodiments detect flickering light sources, and measure the flicker frequency and/or flicker phase and/or flicker strength to enable banding problems to be avoided, for example by setting appropriate exposure periods. By setting a prevailing exposure to avoid flicker, the detection method is made more robust because the first frame will be free from any flicker pattern.

The various embodiments also enable image processing algorithms to adapt according to the levels of natural (steady) and artificial (flickering) illumination across the content of a photographic scene.

The various embodiments can be used to continuously monitor the level and rate of flicker in a scene during view-finding and video capture using the image data rather than additional sensors. The various embodiments detect flicker reliably even if the flicker magnitude varies across a scene. The embodiments enable flicker levels well below other systems to be detected, so that natural and artificial illuminants can be distinguished and hence used to improve the robustness of white balance algorithms.

The embodiments have low computation and buffering overheads. For example, very little computational complexity is required to perform the tasks mentioned above, with only limited memory being needed to store the information being processed.

The flicker detection methods described above have the advantage of avoiding additional hardware such as specific detectors, and mechanisms to determine the camera location, which is mapped to a local flicker frequency. The flicker detection methods also avoid unnecessary reconfiguration of the camera in situations where flicker is determined to be absent. It can enable special image processing methods (such as colour correction) in situations where flicker is determined to be present.

The flicker detection method can run during camera view-finding and video capture so that changes in the illumination can have an immediate effect. It may also be used to generate a map of the strength of flicker across a scene hence enabling content-adaptive processing of the image or video data.

This flicker detection method can use pairs of captured images of a scene taken with different exposures to distinguish banding patterns due to flicker from bands of image content. In some embodiments, the pair will consist of a normal viewfinder image frame and a second, very short exposure frame that can be exposed and read out from the camera sensor without disrupting the flow of viewfinder data.

A ratio (or in some circumstances a scaled difference) of the two images is processed pixel-by-pixel to predict the location of the nearest image row unaffected by banding (i.e. the nearest image row located between a light band and a dark band). The prediction is based on a simple model of the profile of flicker bands along with an estimate of the tonal offset of a pixel (light or dark) and the tonal gradient (the rate of lightening or darkening of the pixel relative to its vertical neighbours), i.e. without knowledge of the local strength. In other words, by identifying the crossing points, the local signal strength of the signal is not required in order to identify the flicker pattern.

The predictions from individual image pixels are then combined to provide a measure of the consistency of the captured images with each of the plausible flicker frequencies. If there is flicker present, the measure allows the most consistent frequency and the flicker phase to be determined.

Once the flicker frequency and phase is known, the same ratio (or scaled difference) of the source images can be reprocessed to estimate the flicker strength at each pixel of the image of the scene.

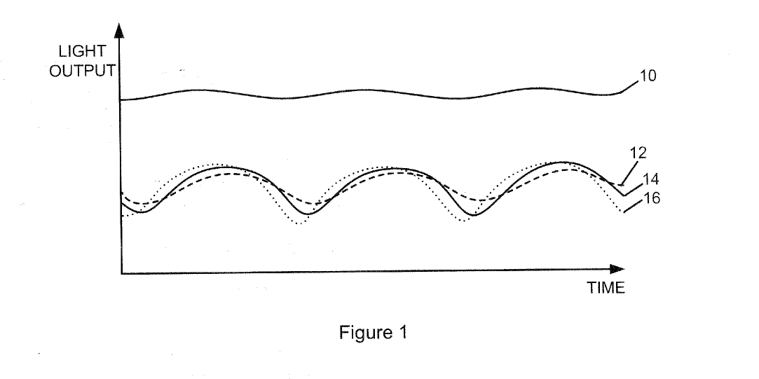

A periodic source such as an incandescent bulb does not turn on and off completely, as seen above from FIG. 1. Indeed, the component of the light output that varies can be very small. Due to the small flickering component, it is sometimes claimed that incandescent bulbs do not cause flicker problems. Even if this is sometimes true, detecting the flicker can still benefit automatic white balance systems because it increases confidence in a particular interpretation of the colors of objects and light sources in the scene. It is common for combinations of periodic light sources and non-periodic light sources to illuminate the same scene further reducing the flickering component in some image regions and making flicker detection and white balancing even more difficult.

Light sources with a flicker index below 0.1 are generally considered to provide flicker-free operation for office workers. Despite this, images captured with these light sources can still exhibit very conspicuous flicker artifacts. A flicker index of around 0.0016 would be needed to ensure that a captured image is free from visible flicker artifacts. Even when a flicker pattern is clearly visible in an image it can be hard to reliably distinguish the flicker pattern from image features, as highlighted by FIGS. 4a and 4b. Therefore, the embodiments described above can enable flicker patterns to be detected automatically even when they would be barely visible.

The embodiments above have been described in relation to a camera having a vertical rolling-shutter arrangement. It is noted, however, that the embodiments are also applicable to any camera system where the exposures of different portions of an image are not entirely concurrent. This includes, but is not limited to, vertical and horizontal rolling shutters, mechanical focal plane shutters, and instances where exposures partially overlap or are entirely distinct. The embodiments are also intended to include cases where equal exposures are time shifted, or cases where exposures are of unequal durations whether or not they partially overlap in time. The embodiments can also be used to determine a flicker rate/phase/strength for purposes other than configuring a camera that is susceptible to flicker.

The various embodiments allow the nature of the flicker to be determined so that any appropriate action can be taken. In some embodiments this can be to set an exposure period that will give a captured image that is unaffected by the particular flicker frequency, for example setting the exposure duration of the rolling-shutter to a period that substantially corresponds to a full illumination cycle, or an integer multiple thereof. Alternatively, the appropriate action can be to determine an appropriate moment to begin or end the exposure of an image (even if all pixels are exposed for the same exact duration) in order to avoid unpredictability in the image brightness due to the timing of the exposure relative to the illumination cycle. The embodiments can also be used to determine the flicker frequency, phase and strength so that image signals can be captured and then corrected during a post-processing step.

Although the embodiments have been described as using first and second exposures to reduce capture and processing overheads (the first and second exposures having different durations or captured at different temporal offsets in the flicker cycle), it is noted that the embodiments are also intended to cover situations in which more than two exposures are used, for example a set of images from a camera. With two or more exposures of different duration or different temporal offset, it is possible to separate the patterns due to flicker from any other patterns in the image content. In some embodiments the exposures occur as close to each other as possible to avoid effects due to subject or camera motion.

It will be appreciated that the embodiments described above take one exposure that tries to minimize visible flicker (i.e. a normal viewfinder or video frame) and one or more additional exposures (for example of about 4.2 ms) which try to maximize it, and uses the original exposure and additional exposure(s) to determine flicker characteristics.

It is noted that in some applications, in order to simplify the detection of flicker according to the embodiments described above, the first image frame may be captured using an exposure that would be impractical for a “real” image. For example, a first image frame can be captured using a exposure that is longer than necessary (giving a partially over exposed image), which is then used with a second image frame to form a third image frame as described above, which is used to detect the flicker pattern. The proper image may then be taken at the correct exposure period, with such an image corrected to remove the effect of flicker as described above.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method of determining flicker in the illumination of a subject, the method comprising the steps of:
capturing a first image frame of said subject;
capturing a second image frame of said subject;
forming a third image frame from at least a portion of said first image frame and a corresponding portion of said second image frame, wherein said third image frame comprises reduced subject information relative to the level of flicker; and
detecting a flicker pattern from said third image frame.

2. A method as claimed in claim 1, wherein the steps of capturing said first and second image frames comprises the steps of:
capturing said first image frame using a first exposure period; and
capturing said second image frame using a second exposure period

3. A method as claimed in claim 2, wherein the second image frame is captured during a time interval between the capture of the first image frame and a preceding image frame in a series of two or more image frames.

4. A method as claimed in claim 3, wherein the exposure period of said preceding image frame is temporarily reduced compared to the first exposure period in order to create a suitable time interval for capturing said second image frame.

5. A method as claimed in claim 1, wherein said step of forming said third image frame comprises the steps of:
determining one or more comparative pixel values, each of said comparative pixel values being a ratio or scaled difference between a pixel value in said first image frame and a corresponding pixel value in said second image frame.

6. A method as claimed in claim 1, wherein the step of detecting a flicker pattern comprises the steps of:
determining a local gradient value by comparing a comparative pixel value of a first pixel in said third image frame with a comparative pixel value of a neighbouring pixel in a column of the third image frame;
determining if said local gradient value is above a threshold value and, if so, estimating where the local gradient value crosses a mean pixel level to produce a crossing point estimate; and
determining the flicker pattern from a histogram of said crossing point estimates.

7. A method as claimed in claim 1, wherein said step of detecting a flicker pattern comprises the step of determining one or more of a flicker frequency, flicker phase or flicker strength from the flicker pattern.

8. A method as claimed in claim 7, further comprising the step of reprocessing a captured image using one or more of the flicker frequency, flicker phase or flicker strength.

9. A method as claimed in claim 7, further comprising the step of using one or more of the flicker frequency, flicker phase or flicker strength to avoid or remove flicker in one or more images, or correct a captured image.

10. An apparatus for determining flicker in the illumination of a subject, the apparatus comprising:
an image capture device for capturing a first image frame of said subject and a second image frame of said subject;
a processing unit adapted to form a third image frame from at least a portion of said first image frame and a corresponding portion of said second image frame, wherein said third image frame comprises reduced subject information relative to the level of flicker; and
a detecting unit adapted to detect a flicker pattern from said third image frame.

11. An apparatus as claimed in claim 10, wherein the image capture device is adapted to capture said first image frame using a first exposure period and capture said second image frame using a second exposure period.

12. An apparatus as claimed in claim 10, wherein said processing unit is further adapted to determining one or more comparative pixel values, each of said comparative pixel values being a ratio or scaled difference between a pixel value in said first image frame and a corresponding pixel value in said second image frame.

13. An apparatus as claimed in claim 10, further comprising filtering means for filtering the third image frame prior to the detecting unit detecting the flicker pattern.

14. An apparatus as claimed in claim 10, wherein the detecting unit is adapted to:
determine a local gradient value by comparing a comparative pixel value of a first pixel in said third image frame with a comparative pixel value of a neighbouring pixel in a column of the third image frame;
determine if said local gradient value is above a threshold value and, if so, estimating where the local gradient value crosses a mean pixel level to produce a crossing point estimate; and
determine the flicker pattern from a histogram of said crossing point estimates.

15. An apparatus as claimed in claim 10, wherein said detecting unit is adapted to determine one or more of a flicker frequency, flicker phase or flicker strength from the flicker pattern.

16. An apparatus as claimed in claim 15, wherein the processing unit is further adapted to reprocess a captured image using one or more of the flicker frequency, flicker phase or flicker strength.

17. An apparatus as claimed in claim 16, wherein the processing unit is adapted to dynamically reprocess a captured image during the capture process of an image.

18. An apparatus as claimed in claim 15, wherein the processing unit is further adapted to avoid or remove flicker in one or more images using one or more of the flicker frequency, flicker phase or flicker strength.

19. A camera operable according to a method of determining flicker in the illumination of a subject, the method comprising the steps of:
capturing a first image frame of said subject;
capturing a second image frame of said subject;
forming a third image frame from at least a portion of said first image frame and a corresponding portion of said second image frame, wherein said third image frame comprises reduced subject information relative to the level of flicker; and
detecting a flicker pattern from said third image frame.

20. A camera comprising an apparatus for determining flicker in the illumination of a subject, the apparatus comprising:
an image capture device for capturing a first image frame of said subject and a second image frame of said subject;
a processing unit adapted to form a third image frame from at least a portion of said first image frame and a corresponding portion of said second image frame, wherein said third image frame comprises reduced subject information relative to the level of flicker; and
a detecting unit adapted to detect a flicker pattern from said third image frame.
